(19) United States
(12) Patent Application Publication
(10) Pub. No.: US 2001/0053172 A1
(43) Pub. Date: Dec. 20, 2001

(54) Temperature measuring device

(75) Inventors: Ullrich Sakowsky, Gladbeck (DE); Matthias Muziol, Seligenstadt (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/883,485

(22) Filed: Jun. 18, 2001

(30) Foreign Application Priority Data
Jun. 19, 2000 (DE) 100 29 186.4-52

(51) Int. Cl. G01K 13/02; G01K 1/14; G01K 7/18

(52) U.S. Cl. 374/147; 374/185; 338/25

(57) ABSTRACT

For measuring temperature of a fluid flowing in a tube, a temperature measuring device is provided with an electric temperature sensor which is securely attached to a tube section so as not to shift in an axial or radial direction. The temperature sensor is applied mechanically fixed on strip conductors on the outer side of the tube section by a thermally and electrically good-conducting paste. The sensor is protected against the outside by a hollow housing, preferably sheath-shaped, surrounding the tube section with a spacing. A connection cabel, electrically and mechanically firmly connected with the sensor, is guided out of the sheath-shaped housing through an opening.

### BACKGROUND OF THE INVENTION

The invention is directed to a temperature measuring device for measuring the temperature of a fluid flowing in a tube, wherein an electric temperature sensor is securely attached to a tube section so that it does not shift radially or axially. The designation “tube” also includes tube-shaped carrying bodies flowed through by a fluid.

From U.S. Pat. No. 4,929.092 a resistance temperature sensor is known, which is provided for measuring the temperature of a flowing fluid in a tube section. For this purpose, the flowed-through tube is provided with an opening surrounded by a flange, through which a sheath projects into the flowed-through tube. The sheath contains a measuring resistor. It has proven to be problematic that the connection using an opening in the flowed-through tube with an additionally welded-on flange is relatively expensive.

### SUMMARY OF THE INVENTION

An object of the invention is to provide a temperature sensor for flowed-through tubes, which has relatively few parts and can be brought into its measuring position at low cost. In particular, a temperature sensor should be provided for a dialysis machine, as is known, for example, from published German patent application DE-OS 21 62 998, wherein the sensor has a tube section whose ends are provided respectively as inlet and outlet for the flowing medium.

This object is hereby achieved in that the temperature sensor is mounted mechanically firmly on the outer side of the tube by means of thermally and electrically good-conducting paste, wherein the temperature sensor is thermally insulated to the outside by a housing that surrounds the tube section at a spacing, and a connection cable electrically and mechanically firmly affixed to the sensor is guided out through an opening of the sheath-shaped housing.

It has proven to be especially advantageous that the flowed-through tube section provided for measurement does not have any openings for passing through a temperature sensor in the fluid area, so that expensive connection flanges or additional sealing measures can be dispensed with.

In a preferred first embodiment, the tube section provided with the temperature sensor is sealed off using two rings arranged coaxially spaced from each other in a sheath-shaped housing. It has proven to be advantageous here that the inner space of the sheath-shaped housing thermally insulates the sensor from the surroundings, so that erroneous temperature data of the sensor due to external influence are avoided. The inner space preferably contains air from the surrounding atmosphere.

The temperature sensor is preferably connected to the end of the connection cable via strip conductors mounted along the tube section.

The sheath-shaped housing, in a preferred embodiment, comprises two semi-cylindrical formed parts connected to each other via a flexible foil hinge. Here, the foil hinge has a pivoting axis that runs parallel to the tube axis. Diametrically opposite the foil hinge, a sealing device is provided, which is formed by at least one hook catching in a recess of the opposing part of the sheath-shaped housing. Preferably, two hooks are arranged spaced along a line parallel to the longitudinal axis, which catch in corresponding recesses of the opposing part, such that the connection cable is clamped in a form-fit manner with its end in the connection area along the separation line of the two parts of the sheath-shaped housing between the two hooks. Thus, a relatively simple assembly is possible in an advantageous way.

In addition, it has proven to be advantageous that a cable tension relief of the end of the connection cable can be produced in a simple way using the housing opening.

Furthermore, the tube section provided with the temperature sensor is surrounded respectively by a sheath-shaped tube section seen in the axial direction, which has a tube connection end constructed as a surrounding ring and/or as a flange. An embodiment of this type is especially suited for a tube connection in dialysis machines, in which the flowing medium is conducted over large parts in flexible tubes.

In an advantageous embodiment, a one-piece tube made of a thermally good-conducting ceramic material is provided as the tube section. Preferably, aluminum oxide is used as the ceramic. The actual temperature sensor is applied as a surface-mounted part, wherein preferably a platinum thin-layer resistor is used as the temperature sensor in a central region of the tube section as a SMD (Surface-Mounted Device) component. An economical manufacture thereby results because of the surface mounting.

It has proven to be advantageous herein that the mounted temperature sensor has a rapid response behavior as a result of the high thermal conductivity of the ceramic.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1a is a schematic and exploded perspective view of the tube section according to the invention.

FIG. 1b is a cross-sectional view of a foil hinge and hook lock between the respective parts of the sheath-shaped housing which are constructed as semi-cylinders.

FIG. 2 is a schematic view of the connection of the temperature measuring device with its tube ends in hose ends (shown broken) as they are used, for example, in a dialysis machine. The connection cable is also shown broken.

FIG. 3 is a schematic longitudinal section the use of a temperature measuring device of the invention in a housing of a function module, for example, a conductivity measuring device or pump device.

### DETAILED DESCRIPTION OF THE INVENTION

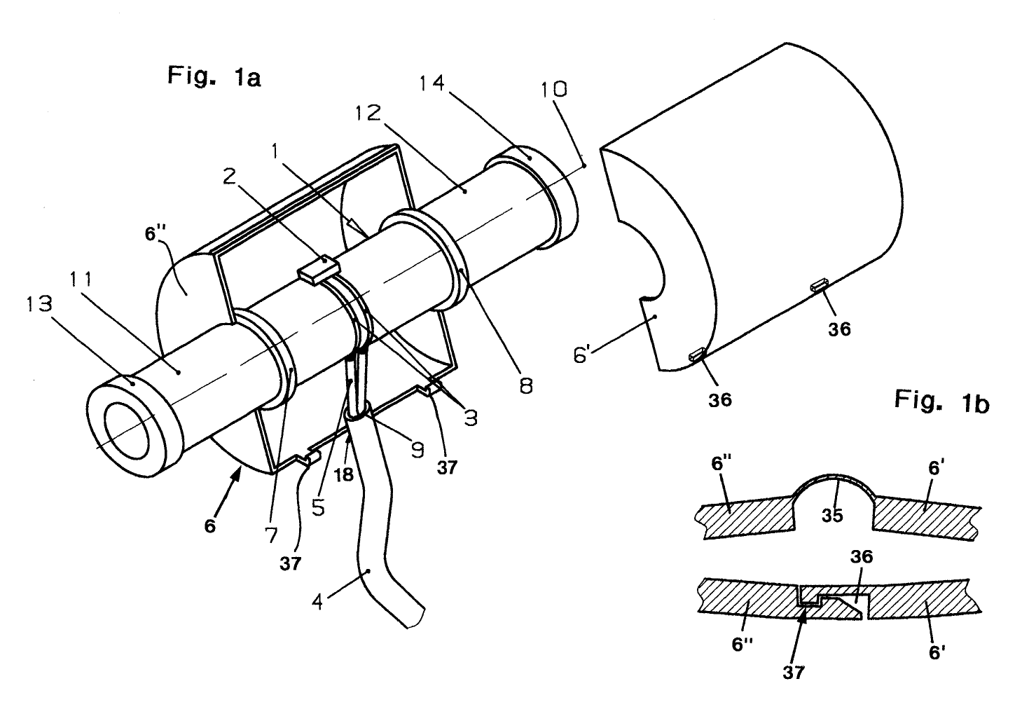

According to FIG. 1a, a temperature sensor 2 is mounted on the outer surface of a central tube section 1, having fluid flowing through it, and is electrically and mechanically affixed, via strip conductors 3 running on the outer circumference of the tube section, to the end 5 of a connection cable 4 leading to the outside.

Both the temperature sensor 2 and the strip conductors 3, together with the end 5 of the connection cable 4, are enclosed by a sheath-shaped housing 6 concentrically surrounding the tube section 1 along the tube axis 10. The sheath-shaped housing 6 comprises two housing parts 6′, 6″. On the tube section 1, respective annular rings 7, 8 are provided for positioning of the housing 6 along the surface of the tube section, wherein the housing 6 is limited by form-fitting of its end surfaces on the rings 7, 8.

The housing 6 creates an interior atmosphere for the temperature sensor 2, wherein the air-filled inner space thermally insulates the measuring element from the surroundings. The inner space of the housing 6 is thus heated up by the fluid flowing in the tube section 11, whereby a possible heat-dissipation via the rear side of the temperature sensor is reduced.

Furthermore, in the radial direction as seen from the tube axis 10, the housing 6 has a through-passage opening 18 for the connection cable 4, which simultaneously creates a cable tension relief by squeezing of the sheath 9 of the connection cable 4.

According to FIG. 1b, the housing 6 is made of two halves 6′, 6″ put together with the aid of a foil hinge 35, wherein the halves thereby joined together can be closed by hooks 37 that catch in a recesses 36.

The tube sections 11, 12 projecting out of the two-piece housing 6 are both provided at their end with an annular flange 13, 14, which is suitable for the connection of hose ends, for example of a dialysis machine. The two flanges 13, 14 thus represent the hose connection ends of the tube section.

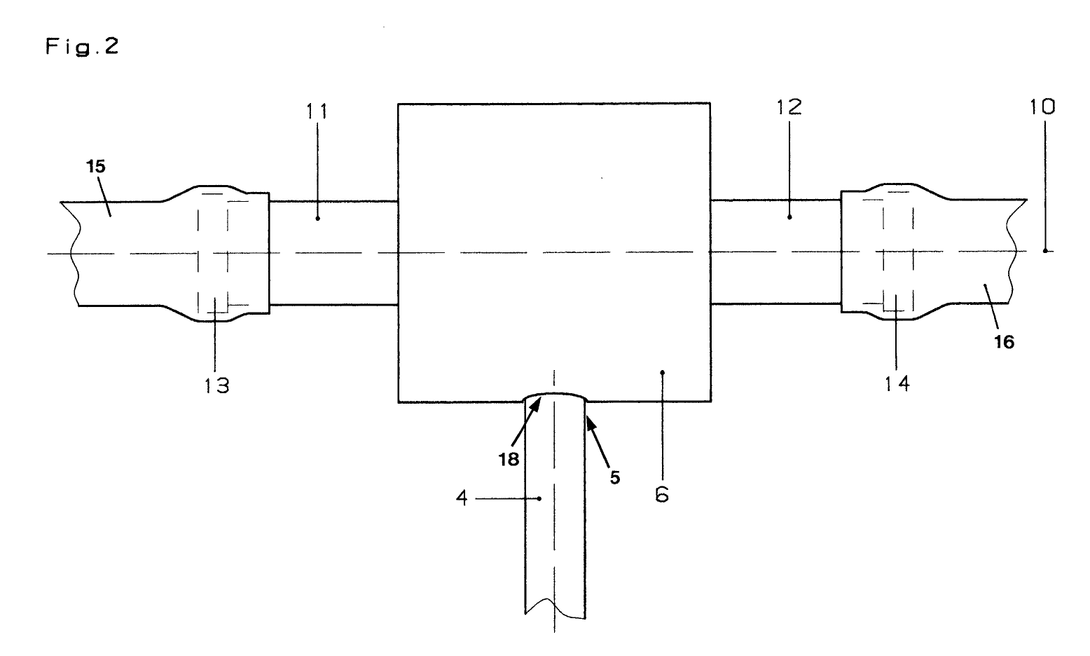

According to FIG. 2, the connection cable 4 is conducted out of the closed housing 6 through the opening 18, wherein the opening 18 simultaneously creates a cable tension relief by form-fitting with the end 5 of the sheath 9 of the connection cable 4. Furthermore, as shown in FIG. 2, the respective connections of hose ends 15, 16, for example of a dialysis machine, are shown in the end regions of the tube sections 11, 12, wherein the actual fastening of the hose ends is accomplished via the respective flange 13, 14 (not visible here, but shown in dashed lines).

As shown in FIG. 2, the end regions 11, 12 of the tube section 1 are thus only partially visible, while the flanges 13, 14 that are sketched in phantom here, are covered by connection ends of tube-hoses 15, 16. An arrangement of this type is especially suitable for use in dialysis machines with a hose tube pump.

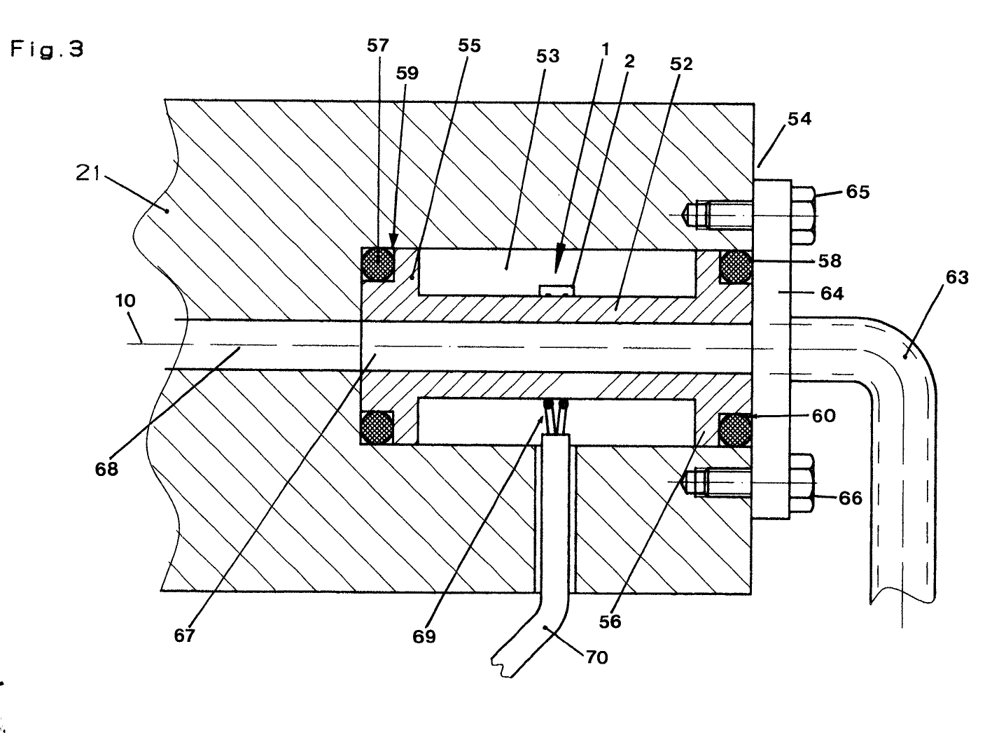

According to FIG. 3, the tube section 1 is constructed as a middle piece of a tube-shaped carrier body 52, which has tube flanges 55, 56 on each of its two ends, which are provided with annular grooves 59, 60 for receiving O-rings 57, 58. The carrier body 52 is located in the hollow space 53 of a housing 21 for a function module, which can be, for example, a pump housing, filter housing, or conductivity measuring device, etc. The housing 21 has on its front end 54 a flange plate 64, with which a tube conduit 63 is connected to the hollow space 53 of the housing 21, wherein because of the carrier body 52 located therein, a flowing fluid flows directly through the hollow cylindrical inner space 67 of the carrier body 21. The fluid flowing through the carrier body 21 is then received by a hollow conduit 68, fitted to the hollow cylindrical inner space 67, within the housing 21.

In order to seal off the fluid that is flowing out of the pipe conduit 63 into the carrier body 52 and into the hollow conduit 68 against the surroundings, the O-rings 57, 58 are placed in the circumferential grooves 59, 60 so that the conduit transitions of the flowing fluid are each sealed off towards the outside. On the tube section 1 of the carrier body 52 is located a temperature sensor 2, which is connected to the ends 69 of a connection cable 70 via strip conductors (not shown here). The ends 69 of the conductors of the connection cable 70 are connected by soldering to the connection regions on the circuit board of the sensor 2.

Using the tube flange 55, 56, the carrier body 52 is secured against shifting both in the axial direction along the tube axis 10 and in the radial direction perpendicularly to the tube axis 10, wherein at the same time, by flush placement of the flange plate 64 and attachment using fastening bolts 65, 66, a secure fixing of the carrier body 52 and an adequate sealing using the O-rings 57, 58 located in the annular ring grooves are obtained.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A temperature measuring device for measuring the temperature of a fluid flowing in a tube, comprising an electric temperature sensor (2) securely attached to an outer side of a central tube section (1) so as not to shift radially or axially, the temperature sensor (2) being outwardly protected by a hollow housing (6, 21) that surrounds the tube section (1) with a spacing therefrom, and a connection cable (4, 70) electrically and mechanically affixed to the temperature sensor (2) and guided through an opening (18) of the housing (6, 21), wherein the temperature sensor (2) is mounted on strip conductors (3) on the outer side of the tube section (1) using a thermally and electrically good-conducting paste.

2. The temperature measuring device according to claim 1, wherein the tube section (1) provided with the temperature sensor (2) is positioned axially in the housing (6, 21) using two spaced apart rings (7, 8).

3. The temperature measuring device according to claim 1, wherein the temperature sensor (2) is connected to an end of the connection cable (4, 70) via the strip conductors (3) mounted along the tube section (1).

4. The temperature measuring device according to claim 1, wherein a surface-mountable temperature sensor (2) is mounted on the tube section (1).

5. The temperature measuring device according to claim 4, wherein a platinum thin layer resistor is mounted as a temperature sensor (2) onto the outer side of the tube section (1).

6. The temperature measuring device according to claim 1, wherein the housing (6) is sheath-shaped, and wherein the tube section (1) on its two ends, as seen in a axial direction, is connected to a respective end tube section (11, 12), which has a hose connection end with a flange (13, 14).

7. The temperature measuring device according to claim 6, wherein the sheath-shaped housing (6) comprises two semi-cylindrically constructed parts (6′, 6″), which are connected to each other via a flexible foil hinge (35).

8. The temperature measuring device according to claim 7, wherein the foil hinge (35) has a pivot axis which runs parallel to an axis (10) of the tube section (1).

9. The temperature measuring device according to claim 8, wherein diametrically opposite the foil hinge (35), a sealing device is provided, which is formed by at least one hook (37) on a first housing part (6′) that catches in a recess (36) of an opposing housing part (6″).

10. The temperature measuring device according to claim 9, wherein two hooks (37) are arranged on the first housing part (6′) spaced along a line parallel to the axis (10), which hooks (37) catch in opposing recesses (36), and wherein the connection cable (4) at its end seen in the axial direction is clamped in a form-fit manner along a separation line of the two housing parts (6′, 6″) between the two hooks (37).

11. The temperature measuring device according to claim 6, wherein all three tube sections (1, 11, 12) are part of a one-piece tube made of a thermally good-conducting ceramic material.

12. The temperature measuring device according to claim 1, wherein the tube section (1) provided with the temperature sensor (2) is a part of a carrier body surrounded by a housing (21) of a function module, wherein the tube section (1) is axially positioned at its two ends with two tube flanges (55, 56).

13. The temperature measuring device according to claim 12, wherein the tube flanges (55, 56) are constructed as spacer elements to also support the carrier body in a radial direction.

14. The temperature measuring device according to claim 12, wherein the tube flanges (55, 56) have annular grooves (59, 60), which are provided to receive O-rings (57, 58) for sealing off the carrier body (52) at its respective intake and outlet against the flowing fluid.
